(19) United States
(12) Patent Application Publication
(10) Pub. No.: US 2006/0239191 A1
(43) Pub. Date: Oct. 26, 2006

(54) METHOD FOR SENDING AND RECEIVING DATA

(76) Inventor: Jen-Li Wang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,083

(22) Filed: Jul. 22, 2005

(30) Foreign Application Priority Data
Apr. 20, 2005 (TW) 94112526

(51) Int. Cl. H04L 12/26; H04J 1/16; H04L 12/28

(52) U.S. Cl. 370/230; 370/235; 370/431

(57) ABSTRACT

A method for sending and receiving data is provided. The method for sending data comprises the following steps. Firstly, monitor a network connection that transmits data and then check whether the network connection has a bandwidth reservation request. If the network connection has no such request, use the remaining bandwidth to send the data. If the network connection has a reservation request, check whether the network connection has a bandwidth reservation. If the network connection has a bandwidth reservation, check whether the reserved bandwidth is enough to send the data. If the reserved bandwidth is enough to send the data, use the reserved bandwidth to send the data. Lastly, if the network connection does not have bandwidth reservation, or if the reserved bandwidth is not enough to send the data, set up a new reserved bandwidth and use the new reserved bandwidth to send the data.

### CROSS-REFERENCE TO RELATED APPLICATION

This application claims the priority benefit of Taiwan application serial no. 94112526, filed on Apr. 20, 2005. All disclosure of the Taiwan application is incorporated herein by reference.

### BACKGROUND OF THE INVENTION

1. Field of the Invention

The present invention relates to a method for sending and receiving data through a network. More particularly, the present invention relates to a method for sending and receiving data whose transmission efficiency is increased through bandwidth reservation.

2. Description of the Related Art

According to the conventional network quality service scheme of transmitting data to a number of clients simultaneously through a server, transmission time to each client is organized according to the importance of the clients. In other words, the client with a higher priority is assigned a longer transmission period while the other client with a lower priority is assigned a shorter transmission period. Therefore, the clients with a lower degree of importance have to spend more time downloading data from the server. For example, the network comprising a server S and two client terminals C1 and C2 as shown in FIG. 1 may transmit data packets as shown in FIG. 2. Among a set of seven packets, six packets P1 are transmitted to the client C1 while only one packet P2 is transmitted to the client C2. It can be imagined that under the condition shown in FIG. 2, the downloading speed for the client C2 is just one-sixth of that of the client C1.

One major defect for this kind of scheduling is that it will take a client having a lower rank a very long period to download important data or a larger quantity of data and render the service provided by the server unrealistically slow. One major objective of the present invention is to resolve this problem.

### SUMMARY OF THE INVENTION

Accordingly, at least one objective of the present invention is to provide a method for sending data that guarantees a minimum network transmission bandwidth to increase transmission efficiency.

At least a second objective of the present invention is to provide a method for receiving data that guarantees a minimum network transmission bandwidth for receiving specific data to increase transmission efficiency.

To achieve these and other advantages and in accordance with the purpose of the invention, as embodied and broadly described herein, the invention provides a method for sending data comprising the following steps. First, monitor a network connection that transmits data and then check whether the network connection has a bandwidth reservation request. If the network connection has no such request, use the remaining bandwidth to send the data. If the network connection has a reservation request, check whether the network connection has a bandwidth reservation. If the network connection has a bandwidth reservation, check whether the reserved bandwidth is sufficient to send the data. If the reserved bandwidth is enough to send the data, use the reserved bandwidth to send the data. Lastly, if the network connection does not have bandwidth reservation, or if the reserved bandwidth is not enough to send the data, set up a new reserved bandwidth and use the new reserved bandwidth to send the data.

In one embodiment of the aforementioned method of sending data, the method of setting up a new reserved bandwidth and use the new reserved bandwidth to send the data comprises the following steps. First, compute the remaining bandwidth and check whether the remaining bandwidth is enough to send the data. If the remaining bandwidth is enough to send the data, set the new reserved bandwidth according to the remaining bandwidth and use the new reserved bandwidth to send the data. If the remaining bandwidth is not enough to send the data, wait until the remaining bandwidth is enough to send the data and then set the new reserved bandwidth according to the remaining bandwidth and use the new reserved bandwidth to send the data.

From another perspective, the present invention also provides a method for receiving data comprising the following steps. First, obtain the next network connection from a receiving list and then check whether there is a data to be received. If the network connection has a data to be received, check whether the network connection has a bandwidth reservation request. If the network connection has no such request, use the remaining bandwidth to receive the data. If the network connection has a bandwidth reservation request, check whether the network connection has reserved bandwidth. If the network connection has reserved bandwidth, check whether the reserved bandwidth is sufficient enough to receive the data. If the reserved bandwidth is enough to receive the data, use the reserved bandwidth to receive the data. Lastly, if the network connection does not have bandwidth reservation, or if the reserved bandwidth is not enough to receive the data, set up a new reserved bandwidth and use the new reserved bandwidth to receive the data.

In one embodiment of the aforementioned method of receiving data, the method of setting up a new reserved bandwidth and use the new reserved bandwidth to receive the data comprises the following steps. First, compute the remaining bandwidth and check whether the remaining bandwidth is enough to receive the data. If the remaining bandwidth is enough to receive the data, set the new reserved bandwidth according to the remaining bandwidth and use the new reserved bandwidth to receive the data.

The operating principle of the present invention includes identifying the specific data that requires bandwidth reservation through user's setting or by monitoring the content of a network connection. Then, a portion of the bandwidth is reserved for the transmission of the specific data between the server and the clients. Thus, the specific data will not be excluded by other data during transmission. As a result, a minimum bandwidth for sending and receiving data is guaranteed and the transmission efficiency of the specific data is improved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a typical server and client group network.

FIG. 2 shows an example of a conventional data transmission through the network shown in FIG. 1.

FIG. 3 is a graph showing the bandwidth distribution in a method of sending and receiving data according to one embodiment of the present invention.

FIG. 4 is a flow diagram showing the steps for sending data according to one embodiment of the present invention.

FIG. 5 is a flow diagram showing the steps for receiving data according to one embodiment of the present invention.

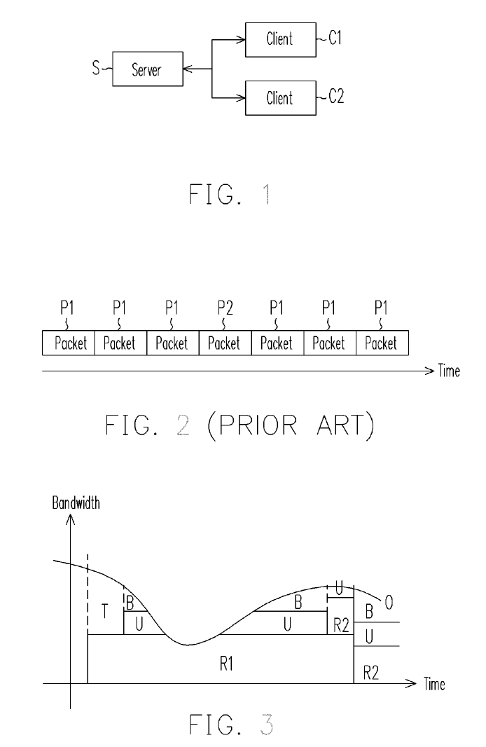

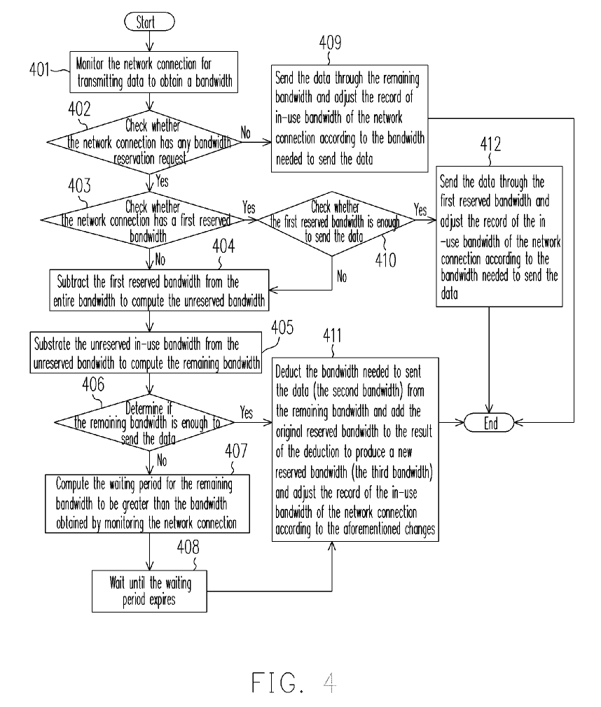

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention works by monitoring the network connection between the clients and the server. According to the bandwidth reservation request to the server provided by the application program which opened the network connection, a portion of the bandwidth between the clients and the server is reserved to be solely used by specific data or a particular transmission protocol, for example, multimedia data. As to the size of the reserved bandwidth, it depends on the specific types of embodiments in the present invention. For example, the reservation may depend on the demand in the application program or may adjust incrementally according to actual application conditions. In addition to the application program, the bandwidth reservation request can be provided through the setting of a user.

The network connection can be intercepted and monitored, for example, by modifying the kernel of an operating system or modifying the link of an application program to the functional library. The advantage for this arrangement is its transparency of the application program. In other words, there is no need to change the existing program codes.

After setting the bandwidth reservation, other application programs can only use the unreserved bandwidth. However, as soon as the aforementioned network connection ends, the reserved bandwidth will be immediately released for other application programs to use.

The present invention is applicable not limited to the multimedia transmission protocol. Any specific data or transmission protocol that can be identified through related network connection parameters of a transmission port, packet content or other specific method is included in the scope of the present invention.

To administer bandwidth reservation, the entire bandwidth of the network must be managed by classification. FIG. 3 is a graph showing the bandwidth distribution in a method of sending and receiving data according to one embodiment of the present invention. As shown in FIG. 3, the letter ‘O’ represents the entire bandwidth or all the usable bandwidths in the network measured by standard network measuring techniques. ‘R1’ and ‘R2’ are two reserved bandwidths each reserved for a different application program (may also be reserved for the same application program but different network connections). ‘T’ represents the unreserved bandwidth or the bandwidth after subtracting the reserved bandwidths ‘R1’ and ‘R2’ from the entire bandwidth ‘O’. ‘U’ represents the unreserved in-use bandwidth or that portion of the unreserved bandwidth ‘T’ in use by an application program without reserved bandwidth. Lastly, ‘B’ represents the remaining bandwidth or the bandwidth after subtracting the unreserved bandwidth ‘T’ from the unreserved in-use bandwidth ‘U’. The descriptions in the following embodiments are based on the classification in FIG. 3.

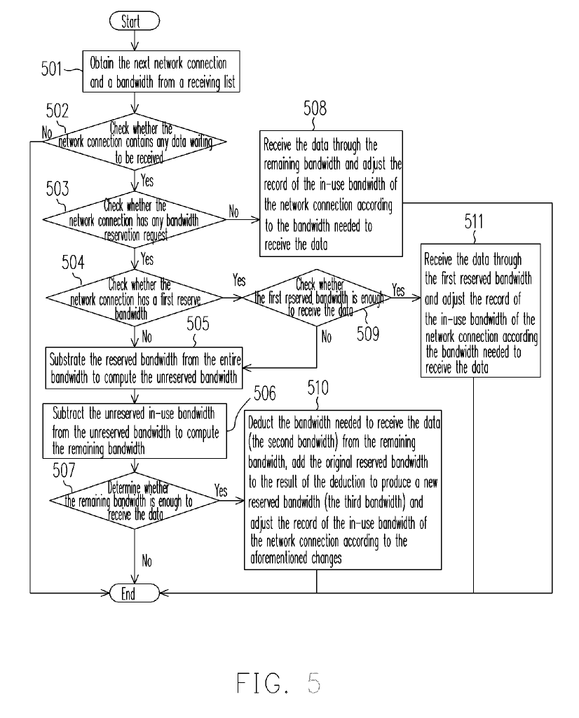

In the following, a detailed description of the method for sending and receiving data in the present invention is provided. FIG. 4 is a flow diagram showing the steps for sending data according to one embodiment of the present invention. The flow in the present embodiment begins from step 401.

First, in step 401, a network connection for transmitting data is monitored to obtain a bandwidth. The monitoring method has been described before and hence will not be repeated here. Then, in step 402, the network connection is checked if there is any bandwidth reservation request. The bandwidth reservation request may originate from the application program or from the settings provided by a user. If the result in step 402 shows that the network connection has no such reservation, then the remaining bandwidth is used to send the data in step 409. Then, according to the needed bandwidth for sending the data, the bandwidth record is adjusted to reflect the current in-use bandwidth status after the data transmission. The flow ends at this point.

On the contrary, if the result in step 402 shows that the network connect has a bandwidth reservation request, step 403 is carried out to check whether the network connection has a first reserved bandwidth. If the network connection has a first reserved bandwidth, the first reserved bandwidth is checked in step 410 whether the first reserved bandwidth is enough to send data (whether the first reserved bandwidth is greater than the bandwidth obtained by monitoring the network connection or not). If the first reserved bandwidth is enough to send the data (the first reserved bandwidth is greater than the bandwidth obtained by monitoring the network connection), the first reserved bandwidth is used to send the data in step 412. Furthermore, the bandwidth record is adjusted according to the bandwidth needed for sending the data to reflect the current in-use bandwidth status after the data transmission. The flow ends at this point.

If the result in step 403 shows that the network connection has no first reserved bandwidth or the result in step 410 shows that the first reserved bandwidth is not enough to send the data (the first reserved bandwidth is smaller than the bandwidth obtained by monitoring the network connection), step 404 is carried out to compute the unreserved bandwidth by subtracting the first reserved bandwidth from the entire bandwidth and then step 405 is carried out to compute the remaining bandwidth by subtracting the unreserved in-use bandwidth from the unreserved bandwidth. Then, in step 406, the remaining bandwidth is checked to determine whether the remaining bandwidth is enough to send the data. If the remaining bandwidth is enough to send the data (the remaining bandwidth is greater than the bandwidth obtained by monitoring the network connection), step 411 is carried out to deduct the bandwidth (a second bandwidth) necessary for sending data from the remaining bandwidth, and then add the original reserved bandwidth to the result to produce a new reserved bandwidth (a third bandwidth), and adjusting the bandwidth record of the network connection according to the changes. The flow ends at this point.

Lastly, if the result in step 406 shows that the remaining bandwidth is not enough to send the data, step 407 is carried out to compute the period needed to wait until the remaining bandwidth is greater than the bandwidth obtained by monitoring the network connection. After the waiting period expires in step 408, step 411 is again executed. The flow ends at this point.

FIG. 5 is a flow diagram showing the steps for receiving data according to one embodiment of the present invention. The flow in the present embodiment begins from step 501.

First, in step 501, the next network connection together with bandwidth is obtained from a receiving list. The receiving list is a data structure for storing information related to all network connections between the server and the clients. In FIG. 5, the flow can be executed a number of times so that each network connection inside the receiving list is dealt with one by one.

In step 502, the network connection is checked to determine if there is any more data to be received. If there is no more data to be received, the flow ends here. If there is some data waiting to be received, step 503 is carried out to check whether there is any bandwidth reservation request. If there is no bandwidth reservation request, step 508 is executed to receive data using the remaining bandwidth and adjust the bandwidth record of the network connection according to the bandwidth required for receiving the data. The flow ends at this point.

On the contrary, if the result in step 503 shows that the network connect has a bandwidth reservation request, step 504 is carried out to check whether the network connection has a first reserved bandwidth. If the network connection has a first reserved bandwidth, the first reserved bandwidth is checked in step 509 to determine whether the first reserved bandwidth is enough to receive the data (whether the first reserved bandwidth is greater than the bandwidth obtained by monitoring the network connection or not). If the first reserved bandwidth is enough to receive the data (the first reserved bandwidth is greater than the bandwidth obtained by monitoring the network connection), the first reserved bandwidth is used to receive the data in step 511. Furthermore, the bandwidth record of the network connection is adjusted according to the bandwidth needed for receiving the data. The flow ends at this point.

If the result in step 504 shows that the network connection has no first reserved bandwidth or the result in step 509 shows that the first reserved bandwidth is not enough to receive the data (the first reserved bandwidth is smaller than the bandwidth obtained by monitoring the network connection), step 505 is carried out to compute the unreserved bandwidth by subtracting the first reserved bandwidth from the entire bandwidth and then step 506 is carried out to compute the remaining bandwidth by subtracting the unreserved in-use bandwidth from the unreserved bandwidth. Then, in step 507, the remaining bandwidth is checked to determine whether the remaining bandwidth is enough to receive the data (whether the remaining bandwidth is greater than the bandwidth obtained by monitoring the network connection or not). If the remaining bandwidth is not enough to receive the data (the remaining bandwidth is smaller than the bandwidth obtained by monitoring the network connection), the reception of the data is suspended and the flow ends. On the other hand, if the remaining bandwidth is enough to receive the data (the remaining bandwidth is greater than the bandwidth obtained by monitoring the network connection), step 510 is carried out to deduct the bandwidth (a second bandwidth) necessary for receiving data from the remaining bandwidth, and then add the original reserved bandwidth to the result to produce a new reserved bandwidth (a third bandwidth), and adjusting the bandwidth record of the network connection according to the changes. The flow ends at this point.

The operating principle of the present invention includes identifying the specific data or transmission protocol that requires bandwidth reservation through user's setting or by monitoring the content of a network connection. Then, a portion of the bandwidth is reserved for the transmission of the specific data between the server and the clients. Thus, the specific data will not be excluded by other data during transmission. As a result, a minimum bandwidth for sending and receiving data is guaranteed and the transmission efficiency of the specific data is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for sending data, comprising the steps of:
(A) monitoring a network connection for transmitting data to obtain a bandwidth;
(B) checking whether the network connection has any bandwidth reservation request;
(C) if the network connection has no bandwidth reservation request, sending the data through a remaining bandwidth;
(D) if the network connection has a bandwidth reservation request, checking whether the network connection has any reserved bandwidth;
(E) if the network connection has a reserved bandwidth, checking whether the reserved bandwidth is greater than the bandwidth;
(F) if the reserved bandwidth is greater than the bandwidth, sending the data through the reserved bandwidth; and
(G) if the network connection does not have a reserved bandwidth or the reserved bandwidth is smaller than the bandwidth, setting up a new reserved bandwidth and sending the data through the new reserved bandwidth.

2. The data sending method of claim 1, wherein the bandwidth reservation request is initiated through user's settings.

3. The data sending method of claim 1, wherein the network connection is opened by an application program, and the bandwidth reservation request is initiated by the application program to a server accepting the network connection.

4. The data sending method of claim 1, wherein the step of using the remaining bandwidth to send the data further comprises:
adjusting the record of the in-use bandwidth of the network connection according to the bandwidth needed for sending the data.

5. The data sending method of claim 1, wherein the step of using the reserved bandwidth to send the data further comprises:
adjusting the record of the in-use bandwidth of the network connection according to the bandwidth needed for sending the data.

6. The data sending method of claim 1, wherein the step of setting up new reserved bandwidth and sending the data through the new reserved bandwidth further comprises:
computing the remaining bandwidth;
determining whether the remaining bandwidth is greater than the bandwidth;
if the remaining bandwidth is greater than the bandwidth, setting a new reserved bandwidth according to the remaining bandwidth and sending the data through the new reserved bandwidth; and
if the remaining bandwidth is smaller than the bandwidth, waiting until the remaining bandwidth is greater than the bandwidth, then setting a new reserved bandwidth according to the remaining bandwidth and sending the data through the new reserved bandwidth.

7. The data sending method of claim 6, wherein the step of computing the remaining bandwidth comprises:
subtracting the reserved bandwidth from an entire bandwidth to compute an unreserved bandwidth; and
subtracting an unreserved in-use bandwidth from the unreserved bandwidth to compute the remaining bandwidth.

8. The data sending method of claim 6, wherein the step of setting the new reserved bandwidth according to the remaining bandwidth and sending the data through the new reserved bandwidth further comprises:
deducting the bandwidth needed to send the data from the remaining bandwidth and adding the original reserved bandwidth to the result of the deduction to produce the new reserved bandwidth; and
adjusting the record of the in-use bandwidth of the network connection according to the previous step.

9. The data sending method of claim 6, wherein the step of waiting until the remaining bandwidth is greater than the bandwidth further comprises:
finding a waiting period for the remaining bandwidth to be greater than the bandwidth through a computation; and
waiting until the waiting period expires.

10. A method for receiving data, comprising the steps of:
(A) obtaining a network connection and a bandwidth from a receiving list;
(B) checking the network connection if any data needs to be received;
(C) if the network connection contains some data that needs to be received, checking whether the network connection has any bandwidth reservation request;
(D) if the network connection has no bandwidth reservation request, receiving the data through a remaining bandwidth;
(E) if the network connection has a bandwidth reservation request, checking whether the network connection has any reserved bandwidth;
(F) if the network connection has a reserved bandwidth, checking whether the reserved bandwidth is greater than the bandwidth;
(G) if the reserved bandwidth is greater than the bandwidth, receiving the data through the reserved bandwidth; and
(H) if the network connection does not have a reserved bandwidth or the reserved bandwidth is smaller than the bandwidth, setting up a new reserved bandwidth and receiving the data through the new reserved bandwidth.

11. The data receiving method of claim 10, wherein the step of using the remaining bandwidth to receive the data further comprises:
adjusting the record of the in-use bandwidth of the network connection according to the bandwidth needed for receiving the data.

12. The data receiving method of claim 10, wherein the step of using the reserved bandwidth to receive the data further comprises:
adjusting the record of the in-use bandwidth of the network connection according to the bandwidth needed for receiving the data.

13. The data receiving method of claim 10, wherein the step of setting up the new reserved bandwidth and receiving the data through the new reserved bandwidth further comprises:
computing the remaining bandwidth;
determining whether the remaining bandwidth is greater than the bandwidth; and
if the remaining bandwidth is greater than the bandwidth, setting up a new reserved bandwidth according to the remaining bandwidth and receiving the data through the new reserved bandwidth.

14. The data receiving method of claim 13, wherein the step of computing the remaining bandwidth further comprises:
subtracting the reserved bandwidth from an entire bandwidth to compute an unreserved bandwidth; and
subtracting an unreserved in-use bandwidth from the unreserved bandwidth to compute the remaining bandwidth.

15. The data receiving method of claim 13, wherein the step of setting the new reserved bandwidth according to the remaining bandwidth and receiving the data through the new reserved bandwidth further comprises:
deducting the bandwidth needed to receive the data from the remaining bandwidth and adding the original reserved bandwidth to the result of the deduction to produce the new reserved bandwidth; and
adjusting the record of the in-use bandwidth of the network connection according to the previous step.

16. A data transmission method, comprising the steps of:
(A) monitoring a network connection for transmitting data to obtain a bandwidth;
(B) checking whether the network connection has any bandwidth reservation request;
(C) when the network connection has no bandwidth reservation request, sending the data through a remaining bandwidth;
(D) when the network connection has a bandwidth reservation request, checking whether the network connection has a first reserved bandwidth;
(E) when the network connection has no the first reserved bandwidth, setting up the first reserved bandwidth and sending the data through the first reserved bandwidth;
(F) when the network connection has the first reserved bandwidth, checking whether the first reserved bandwidth is greater than the bandwidth for sending the data;
(G) when the first reserved bandwidth is greater than the bandwidth, sending the data through the first reserved bandwidth; and
(H) when the first reserved bandwidth is smaller than the bandwidth, setting up a second reserved bandwidth and sending the data through the second reserved bandwidth.

17. The data transmission method of claim 16, wherein the bandwidth reservation request is initiated through user's settings.

18. The data transmission method of claim 16, wherein the network connection is opened by an application program, and the bandwidth reservation request is initiated by the application program to a server accepting the network connection.

19. The data transmission method of claim 16, wherein the step of setting up the second reserved bandwidth and sending the data through the second reserved bandwidth further comprises:
computing the remaining bandwidth;
determining whether the remaining bandwidth is greater than the bandwidth;
when the remaining bandwidth is greater than the bandwidth, setting up the second reserved bandwidth according to the remaining bandwidth and sending the data through the second reserved bandwidth; and
when the remaining bandwidth is smaller than the bandwidth, waiting until the remaining bandwidth is greater than the bandwidth, then setting the second reserved bandwidth according to the remaining bandwidth and sending the data through the second reserved bandwidth.

20. The data transmission method of claim 19, wherein the step of computing the remaining bandwidth comprises:
subtracting the first reserved bandwidth from an entire bandwidth to compute an unreserved bandwidth; and
subtracting an unreserved in-use bandwidth from the unreserved bandwidth to compute the remaining bandwidth.

21. The data transmission method of claim 19, wherein the step of setting the second reserved bandwidth according to the remaining bandwidth and sending the data through the second reserved bandwidth further comprises:
deducting the second reserved bandwidth needed to send the data from the remaining bandwidth and adding the first reserved bandwidth to the result of the deduction to produce a third reserved bandwidth; and
adjusting the record of the in-use bandwidth of the network connection.

22. The data transmission method of claim 19, wherein the step of waiting until the remaining bandwidth is enough to send the data further comprises:
finding a waiting period for the remaining bandwidth to be greater than the bandwidth through a computation; and
waiting until the waiting period expires.
